(19) United States
(12) Patent Application Publication
(10) Pub. No.: US 2009/0106890 A1
(43) Pub. Date: Apr. 30, 2009

(54) BATHING INSTALLATION CONTROL PANEL AND METHOD OF INSTALLATION

(76) Inventor: Paul Rosenau, Santa Ana, CA (US)

Correspondence Address: LAW OFFICES OF LARRY K. ROBERTS, INC., 2 Park Plaza, Suite 300, Irvine, CA, 92614, US

(21) Appl. No.: 11/924,498

(22) Filed: Oct. 25, 2007

(51) Int. Cl. A47K 3/02; H02B 1/00

(52) U.S. Cl. 4/580; 29/428; 361/600

(57) ABSTRACT

An exemplary embodiment of a control panel for a bathing installation includes a housing with a peripheral wall defined by a plurality of overlapping arc-shaped wall portions, and a top cover portion attached to the top edge of the peripheral wall and including a flange portion extending outwardly from the peripheral wall and including a flange lower surface adapted to be secured to a surface of a bathing installation tub surrounding a panel mounting opening in the tub.

An exemplary method for installing a control panel in a bathing installation tub includes forming a mounting opening in a panel mounting surface of the tub by cutting or drilling a plurality of overlapping circular holes, the mounting opening defined by a plurality of resulting overlapping arc-shaped edges defined in the panel mounting surface, and inserting a peripheral wall structure of a control panel through the mounting opening so that a flange portion extending transverse to the peripheral wall surface is brought against the periphery of the panel mounting opening.

### BACKGROUND

Bathing installations such as a spa typically include a tub for holding the bathing water. The tub in many installations may be fabricated of fiberglass. A control panel may be mounted along an edge or lip of the tub, providing ready access to a user in the tub who may wish to monitor or change a bathing installation parameter or feature. Typically, the control panel may have a generally rectangular footprint, and a generally rectangular hole may be cut into the tub edge or lip, e.g. using a saw. This is a time-consuming process.

### BRIEF DESCRIPTION OF THE DRAWINGS

Features and advantages of the disclosure will readily be appreciated by persons skilled in the art from the following detailed description when read in conjunction with the drawing wherein:

FIG. 1 is an isometric view of an exemplary bathing installation tub with an exemplary embodiment of a control panel mounted on a tub surface.

FIG. 2 is a cross-sectional view of the control panel and tub wall depicted in FIG. 1.

FIG. 3 is an isometric view of an exemplary embodiment of a control panel for a bathing installation.

FIG. 4 is a top isometric view of an exemplary embodiment of a panel housing suitable for the control panel of FIG. 3.

FIG. 5 is a bottom side isometric view of the panel housing depicted in FIG. 4.

FIG. 6 is a partially exploded, bottom isometric view illustrating a panel housing and circuit board of a control panel for a bathing installation.

FIG. 7 is a top view of a bathing installation tub surface, illustrating a plurality of overlapping circles to be drilled through the tub surface to provide a panel housing mounting location for the tub.

### DETAILED DESCRIPTION

In the following detailed description and in the several figures of the drawing, like elements are identified with like reference numerals. The figures are not to scale, and relative feature sizes may be exaggerated for illustrative purposes.

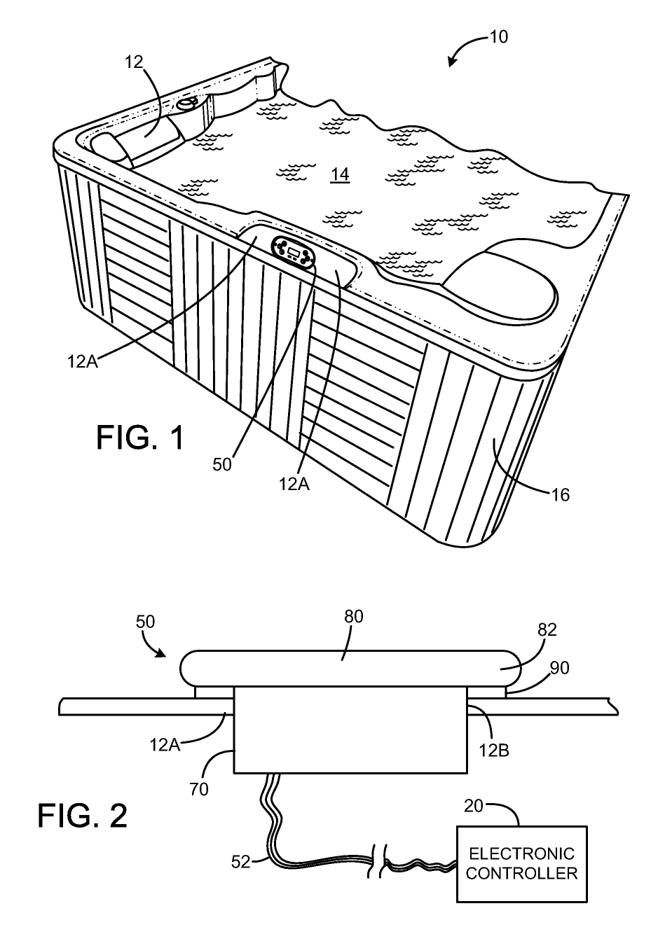

A control panel for a bathing installation is described with respect to FIGS. 1-7. An exemplary bathing installation is a spa having a spa tub, although it will be appreciated that the subject matter may be practiced in connection with other bathing installations such as whirlpool baths and pools. FIG. 1 depicts a spa installation 10 including a tub 12 adapted to hold a volume of bathing water 14. The spa installation may include a side enclosure structure 16 which encloses the sides of the tub and equipment such as a heater, pump, blower and the like. An electronic control system may also be housed in a space between the spa tub and the enclosure structure.

In this exemplary embodiment, a control panel 50 is mounted to the tub wall at a location, e.g., on a tub wall top surface 12A accessible to a spa user. The panel 50 may include a display for displaying information to the spa user, and tactile controls adapted to allow the spa user to control features of the spa, such as the water set temperature, the spa blower, lights and the like.

In many typical spa installations, the tub may be fabricated of a moldable material, such as fiberglass. While the control panel and installation method described herein is well suited to installation in fiberglass tubs, it will be appreciated that the control pane may alternatively be installed in tubs fabricated of other materials, including metal and ceramic materials.

In an exemplary embodiment, the control panel 50 may be installed by drilling or otherwise forming a plurality of overlapping circular holes in the tub wall at the mounting location to form a mount opening, disposing the control panel housing through the mount opening so that a top flange portion of the panel housing is brought against the tub wall surface surrounding the opening, and securing the panel in place by an adhesive gasket or mounting fasteners.

FIG. 2 diagrammatically depicts an exemplary embodiment of a panel 50 with a housing 60 including a peripheral wall structure 70 and a top cover 80. The panel housing wall structure is installed through the mount opening 12B formed in the tub wall 12A, and a flange portion 82 of the cover is attached to the edge of the tub wall surface surrounding the mount opening by an adhesive gasket 90. A wiring harness is connected between the panel 50 and the electronic controller 20 of the spa installation.

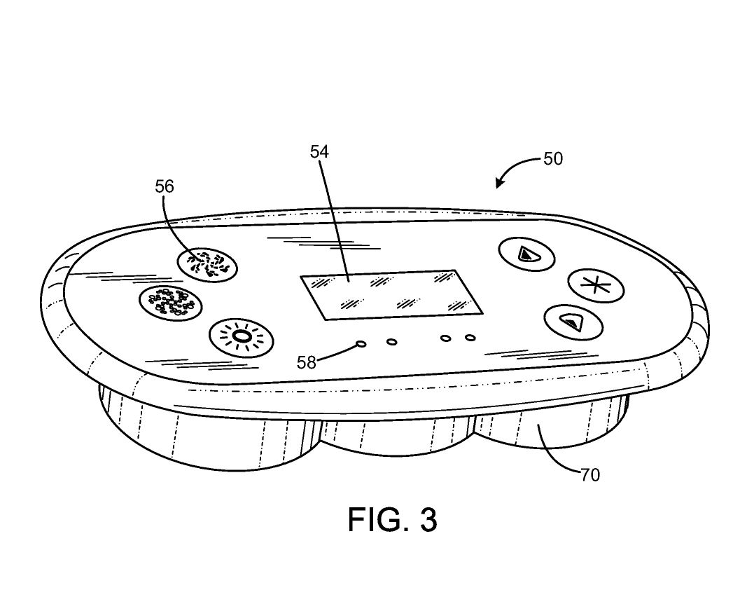

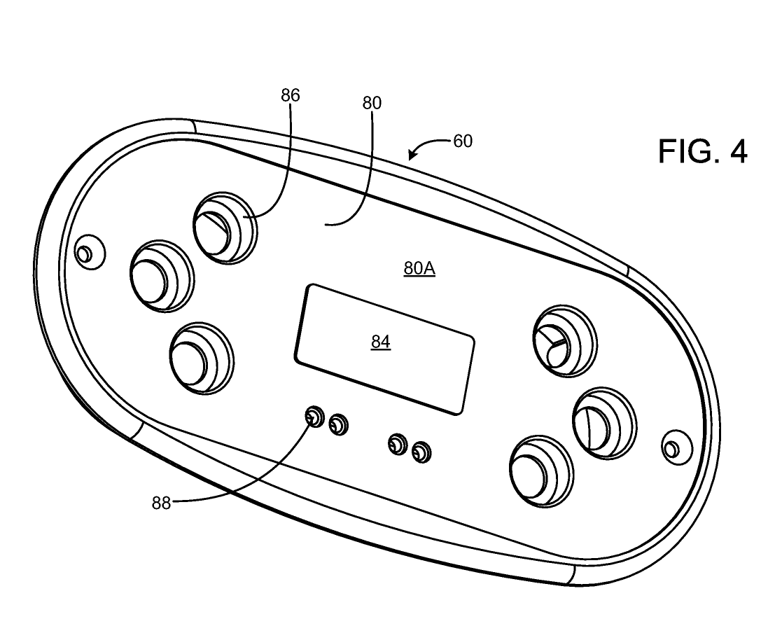

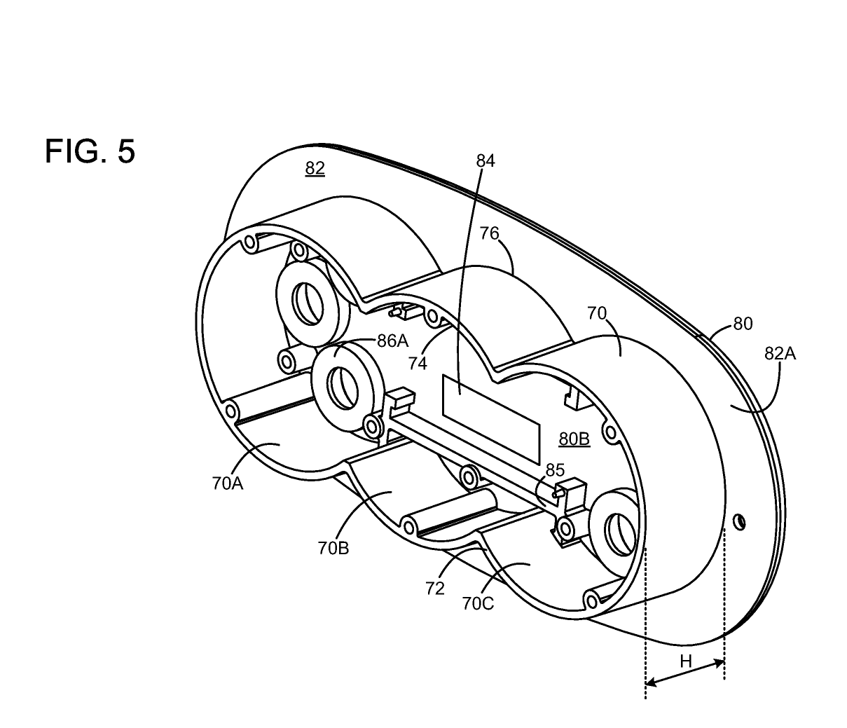

An exemplary embodiment of the control panel 50 is shown in FIGS. 3-6. The panel 50 includes a display 54, e.g. an LCD display, as well as a plurality of buttons 56 and indicator lights 58. The buttons 56 may be touch sensitive buttons which may be activated by a user to control various operating parameters and functions of the bathing installation. The panel includes a housing 60 including a peripheral wall 70 defining a closed housing structure periphery 72 surrounding an interior space 75 (FIG. 5). The wall is defined by a plurality of overlapping arc-shaped wall portions 70A, 70B, 70C. The wall has a height dimension H, a top edge 76 and a bottom edge 74. The height dimension may be selected based on the thickness of the tub wall; in one exemplary embodiment, H is about 15/16 inch. The tub wall thickness can vary, e.g. depending on manufacturing processes, and can vary from spa to spa; exemplary fiberglass wall thicknesses may vary from 0.250″ up to 0.75.″ The tub may be fabricated of materials other than fiberglass; some spa tubs are made using thinner coextruded sheets.

In this exemplary embodiment, the wall portions 70A, 70B, 70C are defined by arcs of overlapping circles of equal diameter, e.g. 2⅜ inches in one embodiment, and whose centers are located on a straight line, with a center-to-center spacing of 1.7 inches. In other embodiments, the circular wall portions may be defined by arcs of circles of non-equal diameters.

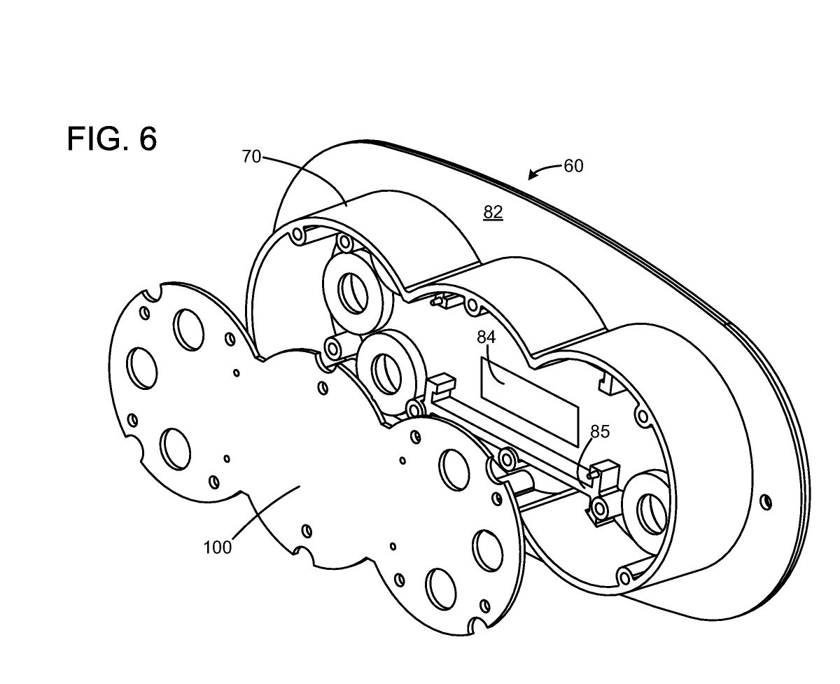

A cover structure 80 is attached to the top edge 76 of the peripheral wall and provides a transverse cover surface 80A over the peripheral wall. Several button recesses 86 are defined in the cover surface 80A, and communicate with bosses 86A extending downwardly from the bottom surface 80B of the cover structure. The bosses accept switch structures carried by a circuit board 100 (FIG. 6). The cover structure includes a flange portion 82 extending outwardly from the peripheral wall 70 and including a flange lower surface 82A (FIG. 5) adapted to be secured to a surface of the bathing installation tub surrounding a panel mounting opening in the tub. A set of recesses 88 are formed in the cover surface 80A to allow light emitted by a corresponding set of indicator lights (e.g. LEDs) mounted on the circuit board 100 to be visible to a user of the bathing installation.

In an exemplary embodiment, the housing structure 60 includes a set of circuit board stand-off features 85 which support the circuit board 100 in a registered position when assembled to the housing structure 60, and which include threaded bores to received circuit board mounting fasteners (not shown).

The circuit board 100 mounts the electronic circuitry for driving the display, as well as the display itself, which may be visible to the user through window 84 in the top plate. The board 100 also supports features of the buttons 56 in an exemplary embodiment, although in other embodiments, the button structures may be carried by the cover, or even omitted entirely, in the case in which the control panel 50 is for display only, or in case in which other tactile control elements are employed, e.g. touch sensitive display screens. The panel 50 may include overlays adhered to the top surface 80A of the top plate, which may carry various indicia identifying assigned functions of the buttons, indicator lights and display elements, and provide a moisture barrier.

In an exemplary embodiment, the housing structure 60 is a unitary structure, e.g. fabricated by injection molding from a plastic material such as polycarbonate or other appropriate thermoplastic.

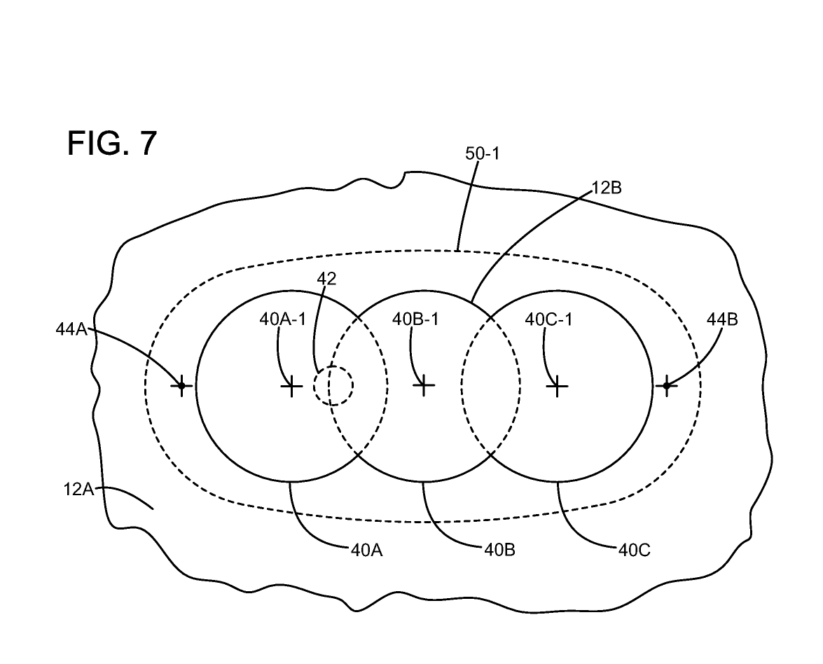

A control panel as described above may be readily installed in a bathing installation tub using a hole cutting technique. FIG. 7 depicts an exemplary panel mounting surface 12A of the tub, with an exemplary hole drilling/cutting layout to form a panel mounting opening 12B represented by the solid line around the periphery of three overlapping holes 40A, 40B and 40C. For mounting a panel as described above regarding FIGS. 3-6, with a peripheral wall defined by arcs of overlapping 2/38 inch circles, each hole 40A, 40B and 40C to be drilled or formed in the tub wall may be a ⅖ inch diameter, e.g. using a hole saw. This provides some clearance to facilitate the mounting of the panel in the panel mounting opening 12B. In one exemplary method for forming the mounting opening 12A, a small hole 42 may be first drilled through the tub wall at the kerf of the hole 40B, to clear chips from the hole saw and speed the drilling of the first hole to be cut, the center hole 40B. The outer holes 40A, 40C may then be cut with the hole saw. This techniques is particularly well adapted for use with fiberglass tubs, but may also be used with other tub materials. Pilot holes 44A, 44B may be drilled for optional fasteners to secure the panel, whose outer periphery is depicted by dashed line 50-1. This exemplary mounting technique does not require the installer to make linear saw cuts, and reduces the time to install the panel. The mounting technique may reduce production time and precisely defines a cutout pattern for the manufacturer that can be reproduced without complicated patterns or difficult saw cuts. In other embodiments, the panel may not include a peripheral wall which conforms to the shape of a mounting opening formed by a plurality of overlapping hole saw cuts. For example, the panel peripheral wall may be oval shaped, with a sufficiently large mounting flange to overlap onto the panel opening. This results is some reduction in the panel volume available to the electronics package, however.

After the mounting opening has been formed, the panel 50 may be installed by inserting the wiring harness through the opening, and inserting the peripheral wall 60 of the panel into the opening until the flange portion 82 is brought against the mounting surface. In an exemplary embodiment, a self-adhesive elastomeric gasket 90 (FIG. 2) attaches the panel flange to the mounting surface. Optional threaded fasteners may be used instead of or in addition to the adhesive gasket. The wiring harness is then connected to the electronic controller 20.

Although the foregoing has been a description and illustration of specific embodiments of the subject matter, various modifications and changes thereto can be made by persons skilled in the art without departing from the scope and spirit of the invention as defined by the following claims.

What is claimed is:

1. A housing for a control panel, comprising:
a peripheral wall defining a closed housing structure periphery, the wall portion defined by a plurality of overlapping arc-shaped wall portions, the wall having a height dimension, a top edge and a bottom edge;
a transverse top cover portion attached to the top edge of the peripheral wall and providing a cover surface over the peripheral wall, the cover portion including a flange portion extending outwardly from the peripheral wall and including a flange lower surface adapted to be secured to a flat surface of a bathing installation tub surrounding a panel mounting opening in the tub.

2. The housing of claim 1, wherein said plurality of overlapping arc wall portions are defined from circles of equal diameters.

3. The housing of claim 1, wherein said plurality of overlapping arc wall portions consists of three overlapping arc wall portions.

4. The housing of claim 1, wherein said peripheral wall and said cover portion are integrally formed as a one-piece housing structure.

5. The housing of claim 1, wherein the wall defines an interior space enclosed by the wall, and wherein the cover portion includes circuit board mounting features adapted to secure a panel circuit board in a registered fixed position within the interior space.

6. A bathing installation, comprising:
a tub for holding a volume of bathing water, the tub having a generally flat panel mounting surface area surrounding a panel mounting opening;
an electronic control panel, including a panel housing, a circuit board, a display and tactile control features, the panel housing including:
a peripheral wall defining a closed housing structure periphery, the wall portion defined by a plurality of overlapping arc-shaped wall portions, the wall having a height dimension, a top edge and a bottom edge;
a generally flat top cover portion attached to the top edge of the peripheral wall and providing a cover surface over the peripheral wall, the cover portion including a flange portion extending outwardly from the peripheral wall and including a flange lower surface adapted to be secured to the panel mounting surface area;
the panel mounting opening in the tub having an opening configuration generally matching the closed housing structure periphery of the peripheral wall and adapted to receive the peripheral wall of the housing into the panel mounting opening, with the flange portion overlaying the panel mounting surface area.

7. The installation of claim 6, wherein the tub is fabricated of fiberglass.

8. The installation of claim 6, wherein the panel mounting opening is formed by drilling a plurality of overlapping circular holes through a panel mounting area of the tub.

9. The installation of claim 6, wherein said plurality of overlapping arc-shaped wall portions are defined from circles of equal diameters.

10. The installation of claim 6, wherein said plurality of overlapping arc-shaped wall portions consists of three overlapping arc-shaped wall portions.

11. The installation of claim 6, wherein said peripheral wall and said cover portion are integrally formed as a one-piece housing structure.

12. The installation of claim 6, wherein the wall defines an interior space enclosed by the wall, and wherein the cover portion includes circuit board mounting features adapted to secure the panel circuit board in a registered fixed position within the interior space.

13. A method for installing a control panel in a bathing installation tub, comprising a sequence of the following steps:
forming a mounting opening in a panel mounting surface of the tub by cutting or drilling a plurality of overlapping circular holes, the mounting opening defined by a plurality of resulting overlapping arc-shaped edges defined in the panel mounting surface;
inserting a peripheral wall structure of a control panel through the mounting opening until a flange portion extending transverse to the peripheral wall surface is brought against the periphery of the panel mounting opening; and
attaching the flange portion to the tub mounting surface.

14. The method of claim 13, wherein the peripheral wall structure is defined by a plurality of overlapping arc-shaped wall portions, and generally matches a peripheral shape o the panel mounting opening.

15. The method of claim 13, wherein said bathing installation tub is a fiberglass tub, and said forming a mounting opening includes:
cutting or drilling the plurality of overlapping circular holes through the fiberglass tub using a hole saw.

16. A method for installing a control panel in a mounting location of a bathing installation tub, comprising:
drilling or otherwise forming a plurality of overlapping circular holes in a tub wall at the mounting location to form a mount opening;
disposing a control panel housing through the mount opening so that a top flange portion of the panel housing is brought against the tub wall surface surrounding the opening; and
securing the panel in place by an adhesive gasket or mounting fasteners.
